(19) United States
(12) Patent Application Publication
(10) Pub. No.: US 2005/0135681 A1
(43) Pub. Date: Jun. 23, 2005

(54) Methods and systems for preventing inadvertent transmission of electronic messages

(76) Inventor: Andrew Lewis Schirmer, Andover, MA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/745,432

(22) Filed: Dec. 22, 2003

(51) Int. Cl. G06K 9/72; G06K 9/00; G06K 9/62; G06K 9/64; G06K 9/66; G06K 9/68

(52) U.S. Cl. 382/229; 382/187; 382/190; 382/209; 382/217; 382/219; 382/220; 382/224

(57) ABSTRACT

The invention provides a methods, systems, and computer software for preventing inadvertent transmission of electronic messages by comparing data in a current electronic message to be sent with data in at least one prior electronic message to determine if at least one condition exists that would indicate that the electronic message is being sent prematurely, and prompting the sender, if at least one condition is identified, that a possible error exists, prompting the sender to confirm sending the electronic message with the possible error prior to sending the message, correcting the possible error automatically or semi-automatically, or a combination thereof.

### COPYRIGHT NOTICE

A portion of the disclosure of this patent document contains material that is subject to copyright protection. The copyright owner has no objection to the facsimile reproduction by anyone of the patent document or the patent disclosures, as it appears in the Patent and Trademark Office patent files or records, but otherwise reserves all copyright rights whatsoever.

### BACKGROUND OF THE INVENTION

The invention disclosed herein relates generally to electronic communications and more particularly to methods and systems for preventing the inadvertent or premature transmission of electronic messages.

In a modem computerized working environment multitasking is made easy. However, there are also many distractions, which, when combined with the ease provided by modem computing, increases the probability of a user making inadvertent errors with regard to individual computing tasks.

For instance, with respect to electronic messaging, the convenience and speed of electronic communication makes it easy for a user to inadvertently send a message before the message is ready to be sent. There are a number of causes for the inadvertent transmission of an electronic message. For instance, the sender may simply send the message accidentally, e.g., by mistakenly hitting the “Send” button or by inadvertently responding “yes” to a prompt asking the sender whether an unsent message should be sent after the sender attempts to close the electronic messaging program. Similarly, the sender may send an incomplete message after an interruption sufficient to cause the sender lose track of the message's level of completion, send the message with comments from or directed to a reviewer that were not intended for the recipients, forget to attach a referenced attachment, forward a message encrypted or encoded in a format non-compatible with the recipients, etc.

Some of the current messaging systems prevent the transmission of electronic messages, for instance, if a user is attempting to send a message without specifying at least one recipient or text in the “Subject” field. Some systems may also be configured to require a generic “send confirmation” prior to sending the message, such as a “Do you really wish to send this message now” prompt. These types of generic solutions, however, do not distinguish between a message the user wants to send and one the user does not want to send. As a result, at least with respect to a send confirmation that is displayed for every message, users view the error check as an annoying interruption and become trained to respond “yes” without giving the prompt much thought.

Accordingly, there is a need for methods and systems that prevent the inadvertent transmission of electronic messages that overcome at least some of the shortcomings associated with current messaging systems in this respect.

### SUMMARY OF THE INVENTION

The present invention addresses, among other things, the problems discussed above with regard to present methods for preventing the inadvertent transmission of electronic messages. In one aspect of the present invention, methods and systems are provided for preventing inadvertent transmission of electronic messages which includes the steps of comparing data in a current electronic message to be sent with data in at least one prior electronic message so as to determine if at least one condition exists that would indicate that the electronic message is being sent prematurely. If at least one such condition is identified, the sender is prompted that a possible error exists, prompted to confirm sending the electronic message with the possible error prior to sending the message, the possible error is corrected automatically without a prompt or semi-automatically with a prompt, or a combination thereof. In one embodiment, the prompt includes a listing of at least one common type of error or a listing each type of the possible errors identified. The listing may further identify the particular error or condition identified.

In one embodiment, electronic messages are prevented from inadvertent transmission by determining if a condition exists that would indicate that the electronic message is being sent prematurely, such as the electronic message is a Reply or Reply to All and a recipient in TO field of the current electronic message does not match an original message sender or recipient, the electronic message is a Reply to All and a recipient in CC field of the current electronic message does not match recipients of a previous electronic message upon which the current message builds, the electronic message is a Reply or Reply to All and a recipient in To or CC fields of the current electronic message was blindly copied in a previous electronic message upon which the current message builds, the electronic message is a Reply or Reply to All and contains an attachment included in a previous electronic message upon which the current message builds, or a combination thereof.

In another embodiment, electronic messages are prevented from inadvertent transmission by determining if a condition exists that would indicate that the electronic message is being sent prematurely, such as the electronic message is a Forward and does not contain an attachment or history included in a previous electronic message upon which the current message builds, the electronic message body refers to an attachment but does not include an attachment, the electronic message is a Reply or Reply to All and contains an attachment or message history included in a previous electronic message upon which the current message builds, the electronic message is encrypted but at least one prior electronic message to a recipient of the current electronic message was not previously encrypted, the electronic message coding appears to be incompatible with at least one recipient of the current electronic message based on coding of at least one prior electronic message to the recipient, or a combination thereof.

In one embodiment, a determination is made as to whether confirmation has been enabled by the sender, and the sender is prompted to confirm sending the electronic message with the possible error only if confirmation is enabled. In another embodiment, a determination is made as to whether error checking has been enabled by the sender, and the electronic data in the current electronic message is compared with data in at least one prior electronic message only if confirmation and error checking are enabled. The selective confirmation default setting may be set with a user defined preference or with a user defined rule.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a flow chart of a method for preventing inadvertent transmission of electronic messages according to an embodiment of the present invention; and

FIG. 2 is a block diagram of an exemplary electronic communication system for preventing inadvertent transmission of electronic messages according to an embodiment of the present invention.

### DETAILED DESCRIPTION

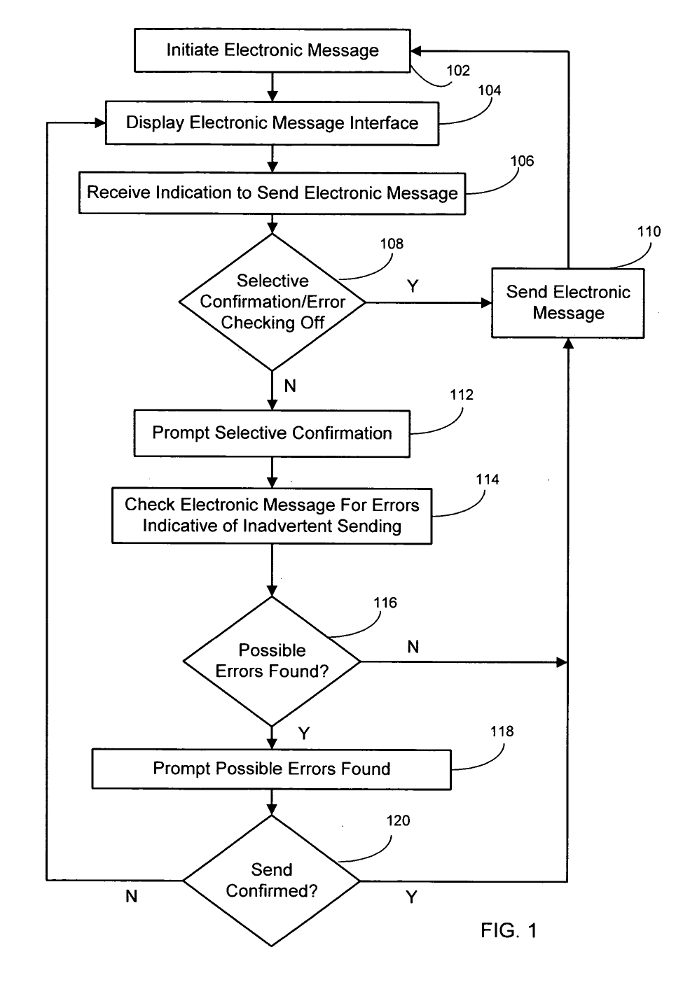

Preferred embodiments of the invention are now described with reference to the drawings. Referring to FIG. 1, a method for preventing inadvertent transmission of electronic messages according to one embodiment of the present invention begins at step 102 with a user initiating an electronic message. The present invention may be adopted to a variety of computing environments, such as in wireless device, desktop, or server based electronic messaging software, such as Lotus Notes, Microsoft Outlook, MSN, Yahoo, or AOL email, etc., and is thus not limited to anyone particular messaging environment. Accordingly, the user may initiate an electronic message on any type of electronic device capable of communicating electronic messages there from, such as a personal computer, a wireless device, etc.

An electronic message may be initiated in a variety of ways. For instance, the user may initiate an electronic message by creating a new message, by replying to or forwarding an existing message, or by opening a draft electronic message. In response, the message system or program displays at step 104 an appropriate electronic message interface or window with one or more fields associated therewith for a user to compose the electronic message. The electronic message interface may include fields for a user to specify one or more recipients, a subject of the message, and the body of the message. The recipient field may be a To field in which the message is intended for the specified recipient, a CC field in which the recipient is copied on the message, or BCC field in which the recipient is blindly copied on the message.

A user may at step 106 select to send the electronic message, such as by selecting the appropriate button or command associated with the messaging program, upon which instance the messaging program, in one embodiment of the invention, determines at step 108 whether the electronic message should be subject to a selective confirmation or error checking. In this respect, the messaging program will determine whether the user has either enabled or disabled confirmation or error checking. In one embodiment, the messaging program allows a user to selectively enable and disable confirmation, error checking, individual types of error checks, or a combination thereof, for the particular initiated electronic message. This may be accomplished, for example, with one or more fields, such as a checkbox, included or associated with the electronic message interface, which allows the user to flag a message as one requiring extra or less attention.

For instance, where the selective confirmation or error checking features are normally off, if the user deems the message trivial, the user may leave the checkbox unchecked, in which instance the messaging program will send the electronic message at step 110 without the selective confirmation or error checking. If on the other hand the box is checked, the program will prompt the user for a confirmation at step 112 with regard to the user's desire to send the message, check the message for errors, or a combination thereof, prior to actually sending the message.

TABLE A
Prompts To Consider Common Errors

Is the message content complete and free of errors?
Are the correct people listed in the To field?
Are the correct people (if any) listed in the CC field?
Are the correct people (if any) listed in the BCC field?
Are attachments (if any) correct?
Should applicable message history be included?
Is the message subject correct?
Is the current encryption setting correct?
Is the current message encoding setting correct?
Is the message too large?
Is the message empty?

The selective confirmation prompt may be a dialog box or window with an appropriate prompt, such as “Are you sure the message is ready to send?”, and Okay and Cancel buttons. In this instance, the user chooses Okay to send, or Cancel to stop the send and return to editing the message. Alternatively, or in addition, the prompt may include a listing of one or more common errors in sending electronic messages prematurely, thereby prompting the user with a prompt, such as those listed in Table A, to consider common types of errors prior to sending the email message. Where the user sets off error checking and the selective confirmation is set on, the messaging program may also require the user to confirm to send the electronic message without error checking. With regard to the selective confirmation aspect of the invention, since confirmation is required on messages selected by the user instead of every message, the likelihood that the user will consider whether the message is ready to be sent before they confirm sending increases.

In another embodiment of the invention, the default setting for the selective confirmation or error checking is set on or off through user defined preferences or rules. For instance, the user may, as a default setting, require a confirmation, error checking, or a combination thereof, for every electronic message or for those messages satisfying a user defined rule, e.g., messages to particular recipients, recipient mailing lists, etc., unless the confirmation or error checking is disabled through the electronic message interface, e.g., with the checkbox, before the message is sent. The preferences or rules may similarly be defined or set by email administrators. An additional administrative setting may also be provided that disables or enables the user's ability to override the default confirmation or error checking settings. In another embodiment, any or all of the above conditions could be set on or off, through user and/or administrative preferences or rules, for one or more of the following conditions: certain recipients, certain recipient roles, certain message domains, certain topics/keywords in title and/or content, certain times of day/days of week, etc. In one embodiment, the error checking occurs, or the dialog box or window always appears automatically without the ability for a user or administrator to selectively enable the feature.

At step 114 the electronic message is checked for possible errors. The term error or errors is used herein to denote a condition or conditions associated with the electronic message would indicate that the electronic message is being sent prematurely. In this instance, the messaging program analyzes the email message and detects whether one or more of such conditions exist. The electronic message may be checked for a variety of different types of conditions. For instance, the message body may be checked, e.g., for spelling or grammatical errors. In one embodiment, the messaging program checks for errors by comparing data in a current message to be sent with data in at least one prior message, such as a prior message upon which the current message builds. For example, the system may previous messages in the current message history to determine whether there may be a wrong or missing name(s) in the To, CC, or BCC fields, that an attachment should be added or removed, that the message should or should not include history in reply, that the encryption or message encoding settings are incorrect or incompatible with that of one or more recipients, etc.

A determination with regard to the message having wrong or missing names in the TO, CC, or BCC fields may be achieved by scanning the message history or previous messages upon which the present message builds and comparing the recipients of the current message to those in the message history. Thus, if a recipient in the message history is not a recipient in a Reply to All electronic message the messaging program may associate the condition with an indication that the message is being sent prematurely. Similarly, the message may be sent prematurely if a recipient in the current message (To or CC fields) was previously BCC'd or blind copied.

With regard to whether the current attachment and message history should be removed, the messaging program may determine whether the attachment or message upon which the present message builds was previously sent to a recipient. If the attachment or, some or all of the message history was previously sent to one or all of the recipients of the current message, the system may prompt the user as to whether the attachment or history should be removed. Similarly, if the message is a Forward and the message body refers to an attachment or has a history associated therewith, and an attachment or history has not been included, the messaging program may prompt the user whether an attachment or message history should be included. For example, if the message text includes terms, such as enclosed, attached, appended, etc., and an attachment is not included in the message, the messaging program may, based on this condition, prompt the user with regard to whether an attachment should be included. The message encryption and encoding error determinations may similarly be based on the previous encryption and encoding from either the message history or from other messages to previously sent to particular recipients. For instance, the current message may be compared with previous messages to the same recipient(s) or to other recipients in the same messaging domain(s) to see whether there is evidence the user or domain supports encryption or particular types of encoding. The settings may then be adjusted per recipient, rather than being changed to the least common denominator.

TABLE B

| Error Condition | Prompts |
|---|---|
| Message has spelling or grammatical errors | The message has possible spelling or |
| | grammatical errors. |
| Message is a Reply or Reply to All and name | Recipient(s) do not match prior message |
| in TO filed does not match original message | sender(s). Is the name(s) in the To field |
| sender | correct? |
| Message is a Reply to All and name(s) in CC | Is the name(s) in the CC field correct? |
| field does not match original message | |
| recipients | |
| Message is a Reply or Reply to All and one of | You may be sending a private message |
| the recipients in To or CC was BCC'd in the | publicly. Are the recipients correct? |
| original | |
| Message is a Reply or Reply to All and | It may not be necessary to include the |
| contains an original attachment, with or | previously sent attachment. Do you wish to |
| without comparing previous recipients | send the message with the attachment? |
| Message is a Forward and does not contain | The previously sent attachment has been |
| the original attachment | removed. Do you wish to include it? |
| Message content refers to an attachment, but | Do you mean to include an attachment? |
| no attachment is present | |
| Message is a Reply or Reply to All and | Do you mean to include the message |
| contains (or does not contain) message history | history? |
| Encryption is on (or off) | Do you mean to send the message |
| | encrypted (unencrypted)? |
| Always or if message is being sent externally, | Should the message encoding be set to |
| e.g., to a different email client | <current setting> for these recipients? |
| Message is large (based on predefined limits) | Do you wish to send a message this large |
| | <xx Kbytes>? |
| Message content is empty | Do you mean to send an empty message? |

In one embodiment, if at step 116 possible errors or conditions that indicate the message may be sent prematurely are identified, the messaging program prompts the user that a possible error has been identified and may ask the user to confirm whether or not to send the message with the possible error or errors at step 118. The prompt preferably includes a list of the type of possible errors found, one or more common type of error, or a combination thereof. In the instance the messaging program determines that a plurality of possible errors exist, the program preferably provides a list of possible types of errors for the user to consider. The messaging program may further specifically identify each of the possible errors found if a particular error is not readily apparent from the notice. A set of error checks and appropriate prompts are provided in Table B. The messaging program may also correct some problems automatically, e.g., without the prompt, or semi-automatically, e.g., with prompt and as directed by user wishes. For example, with respect to the semi-automatic correction, if the user, when prompted, wishes to include or omit historical text omitted or included, as the case may be, the user could, in the confirmation dialog, direct the system to restore or remove, e.g., the historical text before sending. Attachments, encryption, data format, etc., may similarly, be handled semi-automatically. In the cases of encryption and data format, for example, the messaging program may be configured to make the change automatically without a user prompt.

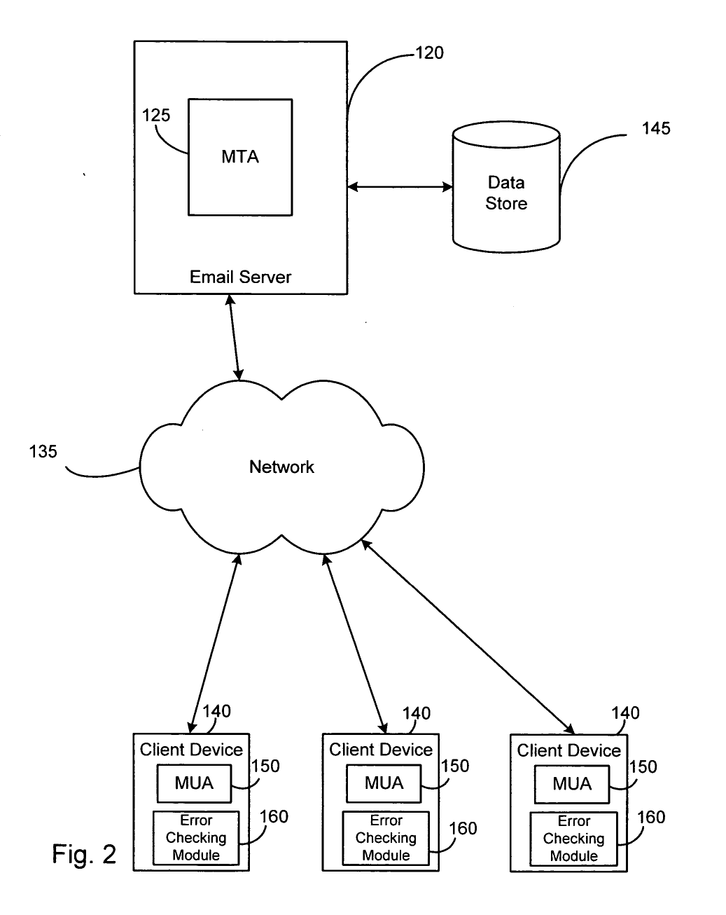

Referring to FIG. 2 an exemplary system for preventing inadvertent transmission of electronic messages according to an embodiment of the present invention includes a mail server 120 executing a message transfer agent 125 (“MTA”), a network 135, one or more client devices 140 executing a messaging program or mail user agent (“MUA”) 150, and a data store 145. The mail server 120 is generally a server or other general-purpose computer having a MTA 125 stored thereon, which when executed provides the store and forward capability for electronic messaging. The client device 140 is any type of electronic device capable of sending and preferably receiving electronic messages, such as a general purpose computer, a wireless device, etc., with a messaging program or MUA 150 stored thereon, such as Lotus Notes, Microsoft Outlook, AOL email software, an Internet browser application, etc., which when executed provides a message interface and performs the send and receive functions. The mail server 120 is connected to a network 135 such as a local area network (“LAN”), a wide area network (“WAN”), a wireless network, the Internet, an Intranet, or other type of network known in the art. One or more client devices 140 communicate with the mail server 120 via the network 135. The data store 145 holds electronic messages until they are selectively retrieved and deleted by the server 120.

It is understood that the functionality described above with regard to the selective confirmation and error checking features of the present invention may be achieved in such a computing environment in a variety of ways. For instance, the relevant functionality may be provided with the MTA 125, the messaging program or MUA 150, or a combination thereof. The functionality may, for instance, be programmed into the respective applications or may be provided with complimentary program modules or APIs. For example, the selective confirmation and error checking functions may be programmed as a part of Lotus Notes or Microsoft Outlook, or may be provided with a separate program that interfaces with the MUA 150, such as an error checking module 160.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. User interface elements described herein may comprise elements from graphical user interfaces, command line interfaces, and other interfaces suitable for the purposes described herein.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for preventing inadvertent transmission of electronic messages comprising:
comparing data in a current electronic message to be sent with data in at least one prior electronic message to determine if at least one condition exists that would indicate that the current electronic message is being sent prematurely; and at least one of
prompting the sender, if at least one condition is identified, that a possible error exists, prompting the sender to confirm sending the electronic message with a possible error prior to sending the message, and correcting the possible error automatically or semi-automatically.

2. The method of claim 1, comprising listing each type of the possible errors identified.

3. The method of claim 1, comprising listing at least one common type of error.

4. The method of claim 1, comprising determining if a condition exists that would indicate that the electronic message is being sent prematurely, the condition comprising at least one of:
the electronic message is a Reply or Reply to All and a recipient in TO field of the current electronic message does not match an original message sender or recipient,
the electronic message is a Reply to All and a recipient in CC field of the current electronic message does not match recipients of a previous electronic message upon which the current message builds,
the electronic message is a Reply or Reply to All and a recipient in To or CC fields of the current electronic message was blindly copied in an a previous electronic message upon which the current message builds, and
the electronic message is a Reply or Reply to All and contains an attachment included in a previous electronic message upon which the current message builds.

5. The method of claim 1, comprising determining if a condition exists that would indicate that the electronic message is being sent prematurely, the condition comprising at least one of:
the electronic message is a Forward and does not contain an attachment or history included in a previous electronic message upon which the current message builds,
the electronic message body refers to an attachment but does not include an attachment,
the electronic message is a Reply or Reply to All and contains an attachment or message history included in a previous electronic message upon which the current message builds,
the electronic message is encrypted but at least one prior electronic message to a recipient of the current electronic message was not previously encrypted, and
the electronic message coding appears to be incompatible with at least one recipient of the current electronic message based on coding of at least one prior electronic message to the recipient.

6. The method of claim 1, comprising determining whether a confirmation has been enabled by the sender, and prompting the sender to confirm sending the electronic message with the possible error only if confirmation is enabled.

7. The method of claim 6, comprising determining whether error checking has been enabled by the sender, and comparing the electronic data in the current electronic message with data in at least one prior electronic message only if confirmation and the error checking are enabled.

8. The method of claim 6, wherein a default setting with regard to selective confirmation is set with a user defined preference.

9. The method of claim 6, wherein a default setting with regard to selective confirmation is set with a user defined rule.

10. A system for preventing inadvertent transmission of electronic messages comprising a client device communicatively connected to a mail server and a data store over a communication network, at least one of the client device and the mail server having software associated therewith that when executed performs the method comprising:
comparing data in a current electronic message to be sent with data in at least one prior electronic message to determine if at least one condition exists that would indicate that the current electronic message is being sent prematurely; and at least one of
prompting the sender, if at least one condition is identified, that a possible error exists, prompting the sender to confirm sending the electronic message with a possible error prior to sending the message, and correcting the possible error automatically or semi-automatically.

11. The system of claim 10, wherein the method comprises listing each type of the possible errors identified.

12. The system of claim 10, wherein the method comprises listing at least one common type of error.

13. The system of claim 10, wherein the method comprises determining if a condition exists that would indicate that the electronic message is being sent prematurely, the condition comprising at least one of:
the electronic message is a Reply or Reply to All and a recipient in TO field of the current electronic message does not match an original message sender or recipient,
the electronic message is a Reply to All and a recipient in CC field of the current electronic message does not match recipients of a previous electronic message upon which the current message builds,
the electronic message is a Reply or Reply to All and a recipient in To or CC fields of the current electronic message was blindly copied in an a previous electronic message upon which the current message builds, and
the electronic message is a Reply or Reply to All and contains an attachment included in a previous electronic message upon which the current message builds.

14. The system of claim 10, comprising determining if a condition exists that would indicate that the electronic message is being sent prematurely, the condition comprising at least one of:
the electronic message is a Forward and does not contain an attachment or history included in a previous electronic message upon which the current message builds,
the electronic message body refers to an attachment but does not include an attachment,
the electronic message is a Reply or Reply to All and contains an attachment or message history included in a previous electronic message upon which the current message builds,
the electronic message is encrypted but at least one prior electronic message to a recipient of the current electronic message was not previously encrypted, and
the electronic message coding appears to be incompatible with at least one recipient of the current electronic message based on coding of at least one prior electronic message to the recipient.

15. The system of claim 10, wherein the method comprises determining whether a confirmation has been enabled by the sender, and prompting the sender to confirm sending the electronic message with the possible error only if confirmation is enabled.

16. The system of claim 15, wherein the method comprises determining whether error checking has been enabled by the sender, and comparing the electronic data in the current electronic message with data in at least one prior electronic message only if confirmation and the error checking are enabled.

17. The system of claim 15, wherein a default setting with regard to selective confirmation is set with a user defined preference.

18. The system of claim 15, wherein a default setting with regard to selective confirmation is set with a user defined rule.

19. A computer readable medium storing program code that when executed on a computerized device causes the computerized device to perform a method for preventing inadvertent transmission of electronic messages comprising:
comparing data in a current electronic message to be sent with data in at least one prior electronic message to determine if at least one condition exists that would indicate that the current electronic message is being sent prematurely; and at least one of
prompting the sender, if at least one condition is identified, that a possible error exists, prompting the sender to confirm sending the electronic message with a possible error prior to sending the message, and correcting the possible error automatically or semi-automatically.

20. The medium of claim 19, wherein the method comprises listing each type of the possible errors identified.

21. The medium of claim 19, wherein the method comprises listing at least one common type of error.

22. The medium of claim 19, wherein the method comprises determining if a condition exists that would indicate that the electronic message is being sent prematurely, the condition comprising at least one of:
the electronic message is a Reply or Reply to All and a recipient in TO field of the current electronic message does not match an original message sender or recipient,
the electronic message is a Reply to All and a recipient in CC field of the current electronic message does not match recipients of a previous electronic message upon which the current message builds,
the electronic message is a Reply or Reply to All and a recipient in To or CC fields of the current electronic message was blindly copied in an a previous electronic message upon which the current message builds, and
the electronic message is a Reply or Reply to All and contains an attachment included in a previous electronic message upon which the current message builds.

23. The medium of claim 19, wherein the method comprises determining if a condition exists that would indicate that the electronic message is being sent prematurely, the condition comprising at least one of:
the electronic message is a Forward and does not contain an attachment or history included in a previous electronic message upon which the current message builds,
the electronic message body refers to an attachment but does not include an attachment,
the electronic message is a Reply or Reply to All and contains an attachment or message history included in a previous electronic message upon which the current message builds,
the electronic message is encrypted but at least one prior electronic message to a recipient of the current electronic message was not previously encrypted, and
the electronic message coding appears to be incompatible with at least one recipient of the current electronic message based on coding of at least one prior electronic message to the recipient.

24. The medium of claim 19, wherein the method comprises determining whether a confirmation has been enabled by the sender, and prompting the sender to confirm sending the electronic message with the possible error only if confirmation is enabled.

25. The medium of claim 24, wherein the method comprises determining whether error checking has been enabled by the sender, and comparing the electronic data in the current electronic message with data in at least one prior electronic message only if confirmation and the error checking are enabled.

26. The medium of claim 24, wherein a default setting with regard to selective confirmation is set with a user defined preference.

27. The medium of claim 24, wherein a default setting with regard to selective confirmation is set with a user defined rule.
